(19) United States
(12) Patent Application Publication
(10) Pub. No.: US 2014/0014061 A1
(43) Pub. Date: Jan. 16, 2014

(54) HIGH-PHOSPHOROUS ELECTROLESS NICKEL (HFEN) TREATMENT FOR BUSHINGLESS CONNECTING ROD

(71) Applicant: Caterpillar Inc., Peoria, IL (US)

(72) Inventors: Brian Jeffrey KOSKEY, Vail, AZ (US); Gerald David Castner, Greenwood, IN (US); Morris Allen White, Indianapolis, IN (US)

(21) Appl. No.: 13/934,395

(22) Filed: Jul. 3, 2013

Related U.S. Application Data
(60) Provisional application No. 61/670,352, filed on Jul. 11, 2012.

(51) Int. Cl. F16C 7/02

(52) U.S. Cl. CPC F16C 7/023
USPC 123/197.3; 427/142

(57) ABSTRACT

A method for treating a bushingless connecting rod, wherein the bushingless connecting rod comprises an elongated rod having a pin end configured to connect with a piston, and a crank end configured to connect with a crankshaft. The pin end includes a bore with an internal diameter. The method includes cleaning the pin end bore, masking and fixturing the pin end bore with elastomeric separators, and providing a high-phosphorous nickel alloy coating on the internal diameter of the pin end bore. The method may be applied to original equipment or to a worn engine undergoing a remanufacturing process.

### CROSS REFERENCE TO RELATED APPLICATIONS

This application claims the benefit of U.S. Provisional Application No. 61/670,352 filed Jul. 11, 2012, the contents of which are expressly incorporated herein by reference.

### TECHNICAL FIELD

The present disclosure relates to methods for improving wear resistance of components of internal combustion engines, and more particularly, to methods of treatment of bushingless connecting rods with high-phosphorous electroless nickel plating.

### BACKGROUND

Internal combustion engines convert chemical energy in fuel into mechanical energy through a series of explosions within a combustion chamber of the engine. These explosions cause pistons of the engine to reciprocate within enclosed spaces called cylinders. Each piston is typically connected to a crankshaft by a connecting rod, such that movement of the piston results in rotation of the crankshaft. A piston generally includes a body having a crown and a skirt that depends from the crown to define the bottom half of the body of the piston. A pin bore is formed in the skirt. The pin bore corresponds to a similar bore at one end of the connecting rod. A pin is placed through the corresponding bores to attach the piston to the connecting rod. The end of a connecting rod having the piston pin bore is commonly referred to as the “pin end.” The other end of a connecting rod, which is fastened to the crankshaft, is commonly referred to as the “crank end.”

During engine operation, each connecting rod experiences tremendous stress under the load of the corresponding piston as force from the explosion is mechanically transferred to the crankshaft. Generally, this stress intensifies with higher engine speeds and engine firing pressures. Under regular conditions, the small end pivot point receives the greatest amount of stress, since it is adapted to facilitate angular movement of the connecting rod relative to the piston pin and piston skirt during the cycle from top dead center to bottom dead center and back. The combination of high loads, temperature, gas pressure, and inertial forces localized at this pivot point requires that the small end of the connecting rod retain heightened properties relating to strength, wear, thermal stress, and lubrication.

To reduce friction and facilitate smooth angular movement, a bronze-alloy or laminate bushing is typically employed between the bore of the small end of the connecting rod and the piston pin. However, bushings add weight to this pivot point and require additional steps in manufacturing and assembly of the engine, both of which are generally undesirable. To counteract these drawbacks, bushingless connecting rods have been developed in the art. These rods are generally designed for iron to steel contact with an oil film as an isolation media. Bushingless connecting rods are attractive largely because of their low initial cost to manufacture. However, the oil film has limited efficiency as a lubricant, and consequently early wear of the bushingless connecting rods after installation is not uncommon.

Moreover, once an engine reaches the end of its original life and is returned for remanufacture, bushingless connecting rods are generally not salvaged primarily because of cost concerns associated with high quality resurfacing within the limited size constraints of the pin bore. Possible salvaging methods that have been explored without the desired success include metal deposition and the use of conventional bushings. Metal deposition does not allow for the highly precise application within the surface of the target bore, and instead creates excessive material build-up within the limited size bore that must be removed through further processing with increased cost. Similarly, installation of conventional bushings has been linked to a high probability of failure due to weakness of the pin end from excessive material removal.

The methods of treatment of bushingless connecting rods according to the present disclosure solve one or more of the problems set forth above and/or other problems in the art.

### SUMMARY

A bushingless connecting rod is disclosed that includes an elongated rod having a pin end configured to connect with a piston and a crank end configured to connect with a crankshaft. The pin end includes a bore with an internal diameter. A high-phosphorous nickel alloy coating is provided on the internal diameter of the pin end bore.

A method is disclosed for remanufacturing worn bushingless connecting rods, wherein each worn bushingless connecting rod comprises an elongated rod having a pin end configured to connect with a piston, and a crank end configured to connect with a crankshaft. The pin end includes a bore with an internal diameter. The method includes cleaning the pin end bore, masking and fixturing the pin end bore with elastomeric separators, and providing a high-phosphorous nickel alloy coating on the internal diameter of the pin end bore.

A method is disclosed for treating a plurality of bushingless connecting rods, wherein each bushingless connecting rod comprises an elongated rod having a pin end configured to connect with a piston, and a crank end configured to connect with a crankshaft. The pin end includes a bore with an internal diameter. The method includes cleaning the pin end bore of each bushingless connecting rod, masking and fixturing each pin end bore with elastomeric separators, stacking a plurality of bushingless connecting rods, such that the pin bores are aligned, and providing a high-phosphorous nickel alloy coating on the internal diameter of each pin end bore.

### BRIEF DESCRIPTION OF THE DRAWINGS

FIG. 1 is a cross-sectional illustration of an engine and bushingless rod that can be treated according to the methods of the present disclosure.

FIG. 2 is an illustration of the pin end bore that can be treated according to the methods of the present disclosure.

### DETAILED DESCRIPTION

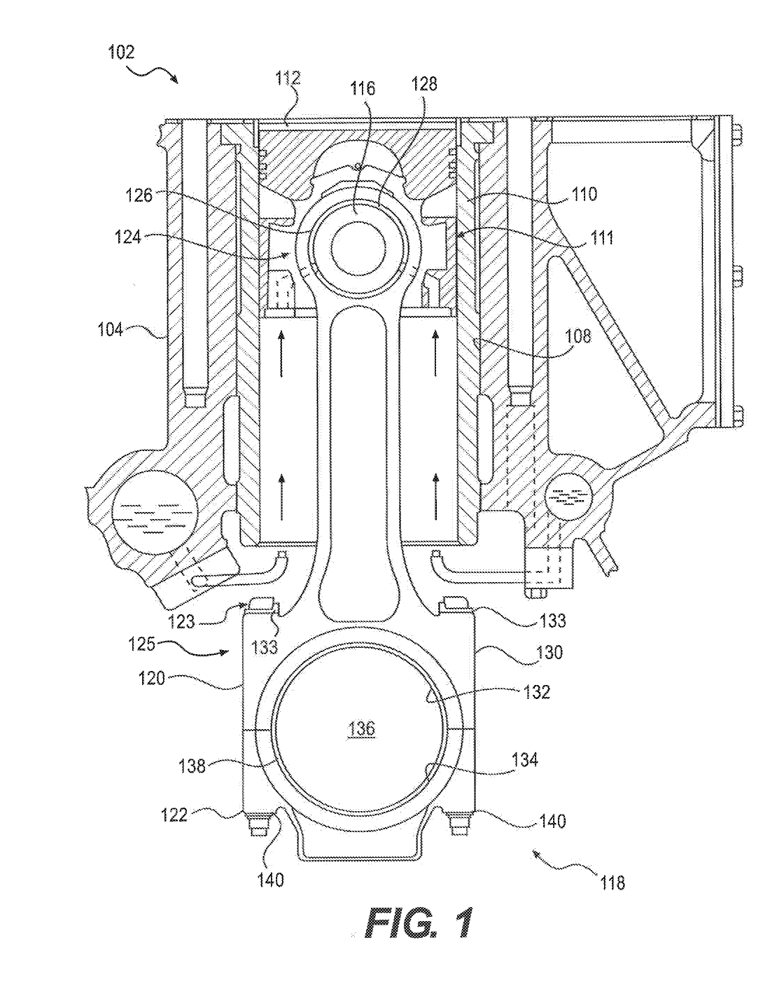

FIG. 1 illustrates an engine 102. Engine 102 is depicted in FIG. 1 and described herein as a diesel-fueled, internal combustion engine. However, it is contemplated that engine 102 may embody any other type of internal combustion engine such as, for example, a gasoline or gaseous fuel-powered engine. It is contemplated that engine 102 may include any number of combustion chambers and that the combustion chambers may be disposed in an “in-line” configuration, in a “V” configuration, or in any other conventional configuration.

Engine 102 may include an engine block 104 at least partially defining a cylinder 108 and a cylinder liner 110 disposed in cylinder 108. A combustion chamber 112 may be formed within cylinder liner 110, and a piston 111 may be located to reciprocate within combustion chamber 112. Engine block 104 may also include a combustion air inlet (not shown), an air scavenging channel (not shown), and an exhaust outlet (not shown) that may be in communication with combustion chamber 112. Piston 111 may include a piston pin 116 that connects piston 111 to a rod assembly 118.

Rod assembly 118 may include an elongated connecting rod 120, a cap 122, and a plurality of connecting rod bolts 123. Connecting rod 120 may include a first end 124 and an opposing second end 125. First end 124 may include an opening 126 that houses a bearing 128. Bearing 128 may have an internal diameter that is sized to receive piston pin 116. Second end 125 may include a yoke 130 having a semi-circular bearing portion 132 and a pair of shoulders 133. Cap 122 may also include a semi-circular bearing portion 134 that, together with semi-circular bearing portion 132, may define a circular opening 136 for receiving a crankshaft (not shown) of engine 102. Circular opening 136 may also include a bearing 138. Bearing 138 may be a friction-type bearing that may be fabricated from a malleable material, for example aluminum. It should be noted, however, that any other suitable material may alternatively be utilized for bearing 138. Cap 122 may include a pair of shoulders 140 that may be disposed generally parallel with shoulders 133 on an opposing side of opening 136.

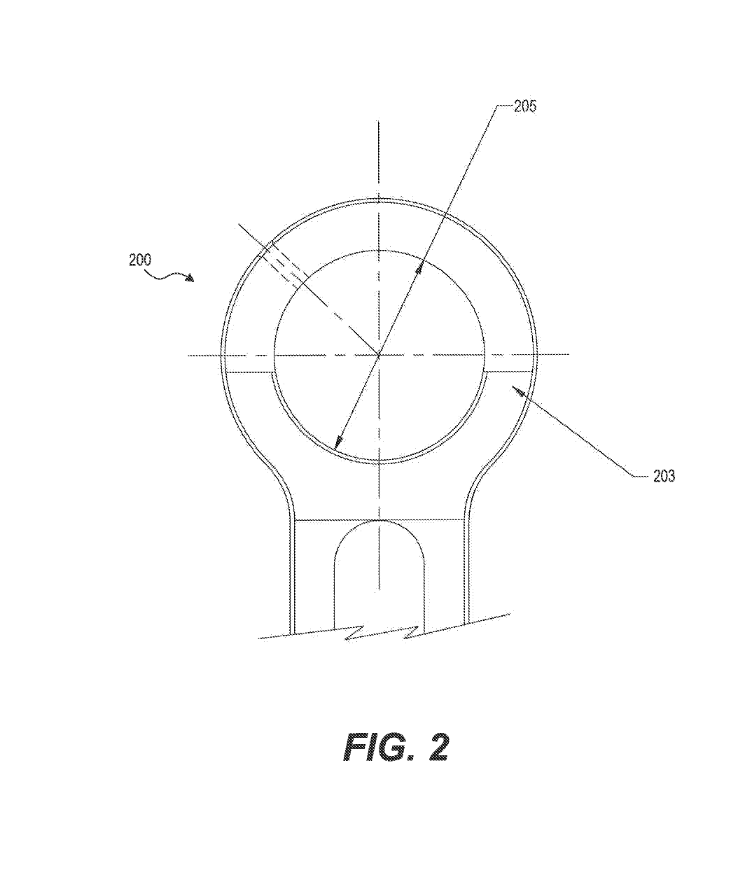

FIG. 2 illustrated an pin end bore 200 that can be treated according to the methods of the present disclosure. Internal diameter 205 is the surface that is treated with the high-phosphorous electroless nickel plating solution. The methods of the present disclosure protect the surface 203 being coated with the high-phosphorous electroless nickel plating material.

The present disclosure may involve a method for providing a wear resistant coating to engine components by high-phosphorous electroless nickel plating. In one aspect, the present disclosure is related to a method of treatment of bushingless rods by high-phosphorous electroless nickel plating. In particular, the methods of the present disclosure are related to the treatment of the pin bore of light duty bushingless connecting rods. The present disclosure further relates to methods of improving the first design life span of a connecting rod, through novel pretreatment methods of its pin bore. In another aspect, the present disclosure relates to improved methods of salvaging worn bushingless connecting rods experiencing irregular pin bore wear or pin bore crowning.

In one aspect, the method according to the present disclosure includes the steps of cleaning the bore to be treated to ensure that it is substantially free of oil and other contaminants; preparing the bore through precision rough boring to a predetermined internal diameter and surface finish; masking the target bore and fixturing it using elastomeric separators to ensure the plating process does not affect non-target areas; plating of the bore with high-phosphorous electroless nickel; precision honing the plated bore to the original print inner diameter and desired surface finish; deburring edges and cleaning of the treated bore; in-process inspecting and audit gauging to ensure quality and conformance of the coated bore; and pre-lubricating the mating parts as required prior to assembly.

In many exemplary embodiments, the present disclosure requires cleaning the surface of the target bore before treatment. Cleaning may include a variety of processes, and the duration and type of cleaning process selected may be vary according to whether the bushingless connecting rod to be treated is an original component or a used component. For example, the surface of the target bore may be degreased with a chemical solvent such as acetone. Alternatively, the target bore may be cleaned by an electrochemical process including alkaline and/or acidic washing. Combinations of grit blasting, degreasing, solvent washing, electrochemical cleaning, or any other suitable technique may be used.

In many exemplary embodiments, the target bore is prepared by exact measurement and precision boring to a predetermined diameter, hatch pattern and surface finish. In many exemplary embodiments, the target bore is fixtured and masked with “elastomeric separators.” Elastomeric separators refer to pieces of chemically resistant material that are shaped and dimensioned to precisely cover the areas of the pin bore that will not be plated during the process. Exemplary shapes are a doughnut-like shape, a disc-like shape and a gasket shape. Any elastomeric material that is chemically resistant to the high-phosphorous electroless nickel plating solution may be used. A non-exhaustive list of elastomeric materials that may be used include neoprene, rubber, viton, and EPDM.

In many exemplary embodiments, the present disclosure provides methods for simultaneously plating more than one connecting rod at the same time. In these exemplary embodiments, the fixtured and masked bushingless connecting rods are stacked up vertically, ensuring that the target bores align with each other. The stack is clamped to a supporting surface. In certain embodiments, the stack of rods is clamped through the crank bores. In one embodiment, six bushingless connecting rods are stacked and plated simultaneously. In another embodiment, nine bushingless connecting rods are stacked and plated simultaneously. The number of rods and the manner in which they are clamped and plated may vary.

Electroless nickel plating is a chemical reduction process that depends upon the catalytic reduction process of nickel ions in an aqueous solution (containing a chemical reducing agent) and the subsequent deposition of nickel metal without the use of electrical energy. In the electroless nickel plating process, the driving force for the reduction of nickel metal ions and their deposition is supplied by a chemical reducing agent in solution. The most common form of electroless nickel plating, i.e., phosphorous electroless nickel, produces a phosphorous nickel alloy coating. The phosphorus content in electroless nickel coatings can vary. The present disclosure relates to the treatment of bushingless connecting rods with high-phosphorous electroless nickel plating. High-phosphorus electroless nickel offers high corrosion resistance, making it suitable for highly corrosive acidic environments such as oil drilling and coal mining. The typical phosphorous concentration in high-phosphorous electroless nickel is greater than 10%. In certain embodiments, the high-phosphorous electroless nickel solution has a phosphorous concentration ranging from about 10% to about 13%. Commercially available high-phosphorous electroless nickel solutions may be used in the methods of the present disclosure.

In one embodiment, once the bushingless connecting rods have been stacked up, the desired amount of high-phosphorous electroless nickel solution is poured in the well formed by the aligned target bores. The solution is allowed to react and plate the bores for a period of time sufficient to achieve coating thicknesses ranging between about 0.0001 inches to about 0.0008 inches. More particularly, a final coating thickness of about 0.0001 inches to about 0.0003 inches has been found to be desirable. The amount of high-phosphorous electroless nickel solution used for the plating may be dependent on various parameters, including the number of bushingless connecting rods to be treated, surface condition, desired coating thickness, and the specific application and concentration of the solution.

In one embodiment, methods of treatment according to the present disclosure further provide for post-treatment of the treated bores. Non-limiting examples of post-treatment steps include precision honing of the plated bore to achieve desirable final diameters and surface finish, edge deburring, and cleaning of the treated bore.

### INDUSTRIAL APPLICABILITY

In one aspect, the present disclosure is directed to wear resistant bushingless connecting rods with pin bores exhibiting a high-phosphorous nickel alloy coating that provides higher resistance to wear. Pre-treating new bushingless connecting rods according to methods of the present disclosure may reduce wear and provide an extended First design life span without the cost and added weight associating with conventional bushings. The phosphorous component retains lubrication and supports oil film retention, while the nickel component provides for a durable base when mated to a hardened shaft or pin. In one embodiment, the treated bushingless connecting rods are originally manufactured components and feature a first design life that may be longer than that of traditional connecting rods. In another embodiment, the treated bushingless rods are originally manufactured components manufactured from powdered metals.

In another aspect, the present disclosure is directed to remanufactured or salvaged bushingless connecting rods, providing a high-phosphorous nickel alloy coating. The salvaged bushingless connecting rods may feature extended wear resistance equal to or greater than normally expected in a remanufactured engine. The use of the disclosed process may allow worn connecting rods to be salvaged during a remanufacturing process, as opposed to being considered a scrap part.

Thus, the present disclosure is related to an improved method of treatment of original equipment and repair of worn bushingless connecting rods through high-phosphorous electroless nickel plating. The methods of the present disclosure may be directed to the simultaneous plating of multiple bushingless connecting rods by stacking masked connecting rods, such that the aligned bores create a “reaction chamber” wherein the high-phosphorous electroless nickel solution may be added for plating. Thus, the methods of the present disclosure allow for an efficient use of the high phosphorous plating solution and for an efficient process of treating multiple rods simultaneously.

It is intended that the specification and examples be considered as exemplary only, with a true scope of the disclosure being indicated by the following claims and their equivalents. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A bushingless connecting rod comprising:
an elongated rod having a pin end configured to connect with a piston, and a crank end configured to connect with a crankshaft, wherein the pin end includes a bore with an internal diameter; and
a high-phosphorous nickel alloy coating on the internal diameter of the pin end bore.

2. A bushingless connecting rod according to claim 1, wherein the high-phosphorous nickel coating comprises phosphorous in an amount greater than about 10%.

3. A bushingless connecting rod according to claim 2, wherein the high-phosphorous nickel coating comprises phosphorous in an amount ranging from about 10% to about 13%.

4. A bushingless connecting rod according to claim 1, wherein the high-phosphorous nickel coating has a thickness ranging from about 0.0001 inches to 0.0008 inches.

5. A bushingless connecting rod according to claim 4, wherein the high-phosphorous nickel coating has a thickness ranging from about 0.0001 inches to about 0.0003 inches.

6. A method for remanufacturing worn bushingless connecting rods, wherein each worn bushingless connecting rod comprises an elongated rod having a pin end configured to connect with a piston, and a crank end configured to connect with a crankshaft, wherein the pin end includes a bore with an internal diameter comprising
cleaning the pin end bore;
masking and fixturing the pin end bore with elastomeric separators; and
providing a high-phosphorous nickel alloy coating on the internal diameter of the pin end bore.

7. The method according to claim 6, wherein the high-phosphorous nickel alloy coating is provided by high-phosphorous electroless nickel plating.

8. The method according to claim 6, wherein the high-phosphorous nickel coating comprises phosphorous in an amount greater than about 10%.

9. The method according to claim 6, wherein the high-phosphorous nickel coating comprises phosphorous in an amount ranging from about 10% to about 13%.

10. The method according to claim 6, wherein the high-phosphorous nickel coating has a thickness ranging from about 0.0001 inches to 0.0008 inches.

11. The method according to claim 10, wherein the high-phosphorous nickel coating has a thickness ranging from about 0.0001 inches to 0.0003 inches.

12. The method according to claim 6, further comprising honing of the coated pin end bore to a final inner diameter; and edge deburring the honed coated end pin bore.

13. A method for treating a plurality of bushingless connecting rods, wherein each bushingless connecting rod comprises an elongated rod having a pin end configured to connect with a piston, and a crank end configured to connect with a crankshaft, wherein the pin end includes a bore with an internal diameter comprising
cleaning the pin end bore of each bushingless connecting rod;
masking and fixturing each pin end bore with elastomeric separators;
stacking a plurality of bushingless connecting rods such that the pin bores are aligned; and
providing a high-phosphorous nickel alloy coating on the internal diameter of each pin end bore.

14. The method of claim 13, wherein the high-phosphorous nickel alloy coating is provided by pouring an aqueous solution into a reaction chamber formed by the stacked plurality of connecting rods.

15. The method of claim 14, further comprising the step of maintaining the alloy in the reaction chamber for a predetermined period of time corresponding to a desired coating thickness.
